(19) United States
(12) Patent Application Publication
(10) Pub. No.: US 2020/0398696 A1
(43) Pub. Date: Dec. 24, 2020

(54) BATTERY MANAGEMENT SYSTEM WITH OPERATING ENVELOPE OUTPUT FOR AN EXTERNAL CONTROLLER

(71) Applicant: Stafl Systems, LLC, San Francisco, CA (US)

(72) Inventor: Erik Stafl, San Francisco, CA (US)

(21) Appl. No.: 16/908,297

(22) Filed: Jun. 22, 2020

Related U.S. Application Data
(60) Provisional application No. 62/863,982, filed on Jun. 20, 2019.

(51) Int. Cl. B60L 58/12; B60L 58/16; B60L 58/24; H01M 10/48; H01M 10/42

(52) U.S. Cl. CPC B60L 58/12; B60L 58/16; B60L 58/24; H01M 2010/4278; H01M 10/4257; H01M 2010/4271; H01M 10/486

(57) ABSTRACT

A battery module with battery cells in a battery pack, and an integrated battery management system (BMS) integrated within the battery module, the BMS having temperature sensors monitoring one or more locations within the battery pack, voltage sensors monitoring voltage at one or more battery cells within the battery pack and current sensors monitoring current of the one or more battery cells within the battery pack. A BMS digital memory stores historical battery module operating information and battery cells characterization data. A BMS microprocessor outputs a battery module safe operating limit, based at least in part on the temperature sensors, the voltage sensors, the current sensors, at least one of the historical battery module operating information and the one or more battery cells characterization data.

### CROSS-REFERENCE TO RELATED APPLICATION(S)

This application claims the priority and benefit of U.S. Provisional Patent Application No. 62/863,982, filed Jun. 20, 2019, the content of which is hereby incorporated by reference in its entirety.

### FIELD

The present disclosure relates in general to battery management systems, and in particular to integration of a battery management system with external control systems.

### BACKGROUND

As battery cell technology and manufacturing capacity improves, electric battery cells are used in an increasingly wide variety of applications. For example, high-power yet cost-effective battery packs are critical to the commercial viability of electric cars and other motive applications that may have traditionally been powered by non-electric means. Battery systems are also increasingly used for energy storage in solar panel applications, as well as a wide variety of other industrial and consumer applications.

However, there may be a number of design challenges in engineering systems utilizing battery packs, particularly for large format battery packs having large cell counts, with high power density. Battery module performance, reliability, longevity and even safety may be critically impacted by the manner in which electrical loads are applied to a battery module. Battery modules therefore commonly include a battery management system (“BMS”) outputting numerous parameters describing the current state of a battery pack. Systems integrators must therefore carefully develop load controllers capable of controlling the operation of an electrical load (e.g. controlling acceleration and deceleration of an electrical vehicle motor), while simultaneously monitoring myriad battery parameters in substantially real time, seeking to balance system performance demands with battery module limitations and operating constraints.

It may therefore be desirable to improve the precision with which a battery module is controlled, in order to improve the module's performance, longevity, reliability and/or safety. It may also be desirable to reduce the complexity of a system integrator's controller task in order to, e.g., reduce development time and cost. These and other benefits may be provided by some embodiments disclosed herein.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

For example, in one or more systems, methods and apparatuses are provided wherein a battery management system is integrated with a battery pack, which enables individual battery pack performance assessment and management. An envelope of safe operation limits or ranges is synthesized by the battery management system and output to a bus to a system controller. Other aspects and variations are also described below.

In one aspect of the disclosed embodiments, a battery module is provided, comprising: a plurality of battery cells within a battery pack; a battery management system integrated within the battery module, the battery management system comprising: one or more temperature sensors monitoring one or more locations within the battery pack; one or more voltage sensors monitoring voltage at one or more battery cells within the battery pack; one or more current sensors monitoring current of the one or more battery cells within the battery pack; a digital memory storing at least one of historical battery module operating information and one or more battery cells characterization data; and a microprocessor outputting a battery module safe operating limit, based at least in part on outputs from the temperature sensors, the voltage sensors, the current sensors, at least one of the historical battery module operating information and the one or more battery cells characterization data.

In another aspect of the disclosed embodiments, the above module is provided, wherein the safe operating limit is synthesized as a safe operating envelope (SOE) output, which is indicative of safe operation limits or ranges and is a characterization of operational constraints to be placed on the battery module; and/or wherein the historical battery module operating information contains at least one of historical duty cycles, peak and sustained discharge rates, prior operating temperatures, and battery module age; and/or wherein the SOE includes a substantially real-time maximum recommended battery module output or input; and/or wherein the microprocessor also outputs at least one reading of the temperature sensors, the voltage sensors, and the current sensors; and/or further comprising: a digital communication bus, receiving at least one of a state data, warning information and the SOE; and/or wherein the state data includes at least one of a state of charge (SOC) in the battery pack, state of health (SOH) of the battery module, one or more voltage levels, one or more temperature readings, and a battery module current level; and/or further comprising a management unit, external to the battery module and coupled to the communication bus; and/or further comprising a load controlled by the management unit; and/or wherein the load is an inverter; and/or wherein the load is an electrical motor; and/or wherein the electrical motor is in a vehicle; and/or wherein the digital bus is a Controller Area Network BUS; and/or further comprising a plurality of the battery modules, each battery module containing a plurality of battery cells within a battery pack, and a battery management system integrated within each battery module; and/or wherein the one or more battery cells characterization data is from a manufacturer of the battery cells.

In yet another aspect of the disclosed embodiments, a battery management system is provided, comprising: temperature sensors; voltage sensors; current sensors; a digital memory storing a historical battery module operating information and battery cell characterization data; and a microprocessor outputting a battery module safe operating limit, based at least in part on outputs from the temperature sensors, the voltage sensors, the current sensors, at least one of the historical battery module operating information and the battery cell characterization data.

In yet another aspect of the disclosed embodiments, a method for controlling the operation of an electric device powered by a high-density battery module is provided, the method comprising: determining, by a microprocessor integrated within the battery module, a characterization of constraints which provide a range of currently acceptable operating conditions on the battery module, based on local sensor measurements of the battery module and information stored within the battery module concerning historical module operations and battery characteristics; transmitting the characterization of constraints on to a system management unit via a shared digital communications bus; and controlling, by the system management unit, the operation of a load circuit to avoid exceeding the characterization of constraints.

In yet another aspect of the disclosed embodiments, the above method is provided, wherein the characterization of constraints is locally synthesized; and/or further comprising storing the battery module's manufacturer's cell characterization information within the battery module; and/or further sending from the battery module, a battery state data and warning to the system management unit.

These and other aspects of the systems and methods described herein will become apparent in light of the further description provided herein.

### BRIEF DESCRIPTION OF THE FIGURES

FIG. 1 is a schematic block diagram of an electric-powered system, in accordance with one embodiment.

FIG. 2 is a schematic block diagram of information and control data flow within a prior art system.

FIG. 3 is a schematic block diagram of information and control data flow within a battery management system embodiment.

FIG. 4A is a schematic block diagram of a battery management system.

FIG. 4B is a block diagram of a SOE calculator.

FIG. 5 is a plot of potential battery pack operating conditions.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

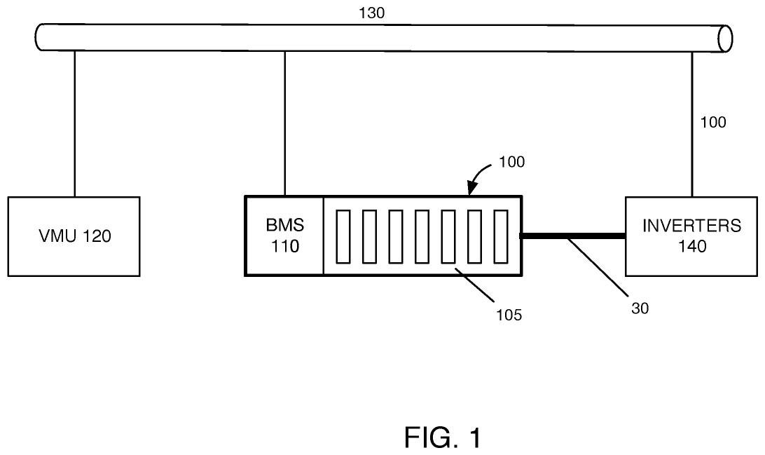

FIG. 1 is a schematic illustration of a typical application for a battery-powered system, such as an electric vehicle. Battery module 100 includes high density battery pack 105, and integrated battery management system (BMS) 110. Battery module 100 drives inverters 140 via power output 30. BMS 110 may include a number of interconnections with battery pack 105, including a number of temperature sensors, voltage sensors and current sensors distributed throughout the battery pack, monitoring operating conditions associated with various portions of the pack. The use of such sensors and interconnections are well known in the art and therefore are not described or illustrated herein, as being inherent to most battery management systems. BMS 110 then communications with vehicle management unit (VMU) 120 via a digital communications bus 130. In vehicle applications, digital communications bus 130 is commonly implemented using the CANBUS standard (e.g., Controller Area Network BUS). VMU 120 in turn transmits control signals to vehicle drive inverters 140, which are driven by current from battery pack 105, and which inverters 140 in turn supply power to electric motors or other loads (not shown) within the system. While VMU 120 is referred to as a vehicle management unit, it is contemplated and understood that in non-vehicular applications (such as stationary energy storage or other industrial applications), VMU 120 may instead be another system controller, external to battery module 100, involved in control of an electrical load to be powered by battery module 100.

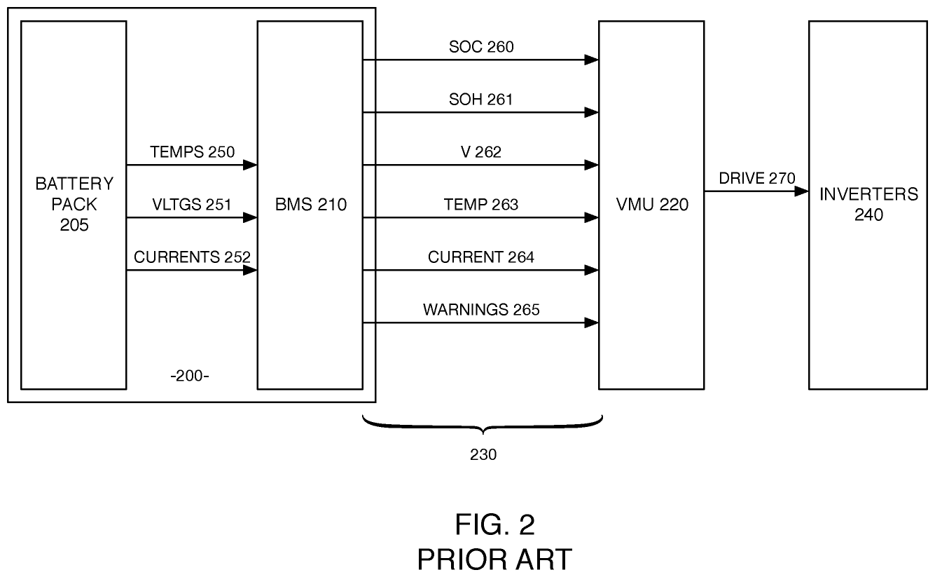

FIG. 2 illustrates control signaling in a prior art implementation. Battery module 200 includes battery pack 205 and BMS 210. BMS 210 utilizes numerous sensors and/or electrical access points within battery pack 205 to measure operating parameters associated with the battery module 200. For example, the embodiment of FIG. 2 illustrates one or more temperature sensor outputs 250, one or more voltage monitoring lines 251, and one or more current monitoring lines 252. BMS 210 may in turn convey state information to VMU 220 via CANBUS 230. The state information may include direct measurements of battery pack 105, some subset of such measurements, and/or information derived from such measurements. Common parameters provided to VMU 220 by BMS 210 include state of charge (SOC) 260 (e.g. the present amount of energy stored in the battery pack 205, potentially expressed as a percentage of maximum capacity), state of health (SOH) 261 (e.g. the recoverable capacity of the battery module 200, typically expressed as a fraction of beginning of life capacity), one or more voltage levels 262, one or more temperature readings within the battery module 263, and module current levels 264. BMS 210 may also provide a variety of warnings and fault notifications 265. Battery module operating parameters 260-265 may then be considered by VMU 220 in controlling system operations (such as driving inverters 240 or otherwise implementing desired vehicle operations, without causing battery module 200 to exceed permissible operating conditions). For example, VMU 220 may observe battery module temperature signals 263 indicating that module 200 is reaching a maximum permissible operating temperature, and subsequently limit maximum drive level conveyed to inverters 240 by VMU 220 in drive signal 270, regardless vehicle throttle position or other performance demands.

The arrangement of FIG. 2 may present, in some applications, certain disadvantages. For example, because communications between BMS 210 and VMU 220 are typically conducted over a system wide communications bus (such as CANBUS), bus 230 may impose bandwidth limitations on the volume of data conveyed from BMS 210 to VMU 220. Transmitting battery state information over bus 230 may consume bandwidth on bus 230 that could otherwise be available for other uses. BMS 210 may also face constraints in order to avoid flooding bus 230 and potentially interfering with communications amongst other devices on the bus 230. BMS 210 may aggregate multiple measurements internal to battery module 200, into a single measurement to be transmitted over bus 230. For example, module 200 may include numerous temperature sensors 250 independently sensing battery temperature for each of multiple cell groups. However, to improve off-module communications efficiency, BMS 210 may derive an aggregated temperature reading for transmission over bus 230 to VMU 220, such as an average temperature or a maximum temperature. Similar data set reductions may be performed by BMS 210 with regarding to voltage levels, current levels and other parameters.

BMS 210 may also seek to efficiently utilize communications bus bandwidth by reducing the frequency of parameter transmission. For example, BMS 210 may measure voltage levels at numerous locations within battery module 200, at a first sample rate that is relatively high. However, voltage levels 262 broadcast by BMS 210 to VMU 220 may be at a substantially lower frequency, in order to avoid swamping bus 230.

While such compromises may facilitate integration within a system, they may also constrain the ability of a VMU to most effectively evaluate battery module operations. Information may be limited and/or delayed. Some battery evaluations may involve integrating time-series measurements; by reducing measurement sample frequency, the accuracy of such integrations may be compromised.

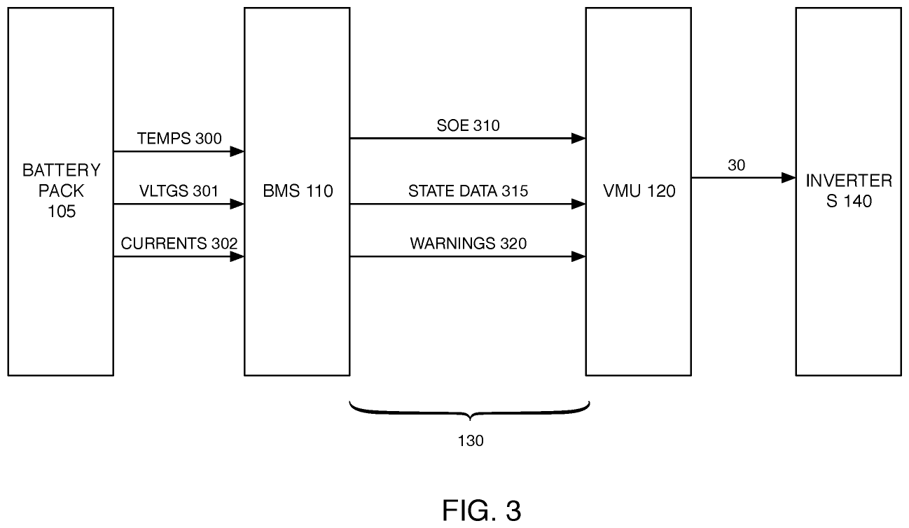

FIG. 3 illustrates an alternative signaling arrangement, in which a BMS 110 integrated within a battery module leverages in-module measurement and processing capabilities to locally synthesize an output indicative of a range of operating conditions currently deemed acceptable for the battery module, sometimes referred to by the present applicant as a Safe Operating Envelope (“SOE”), and which may include various safe operation limits or ranges.

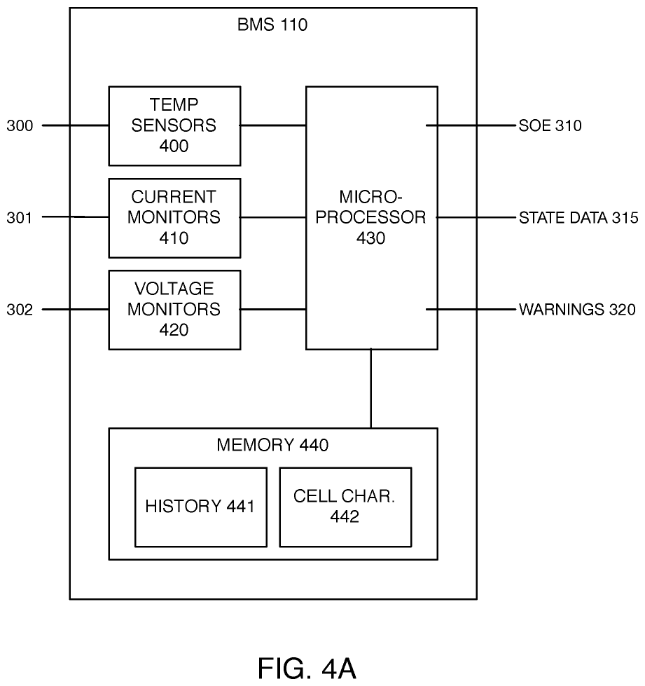

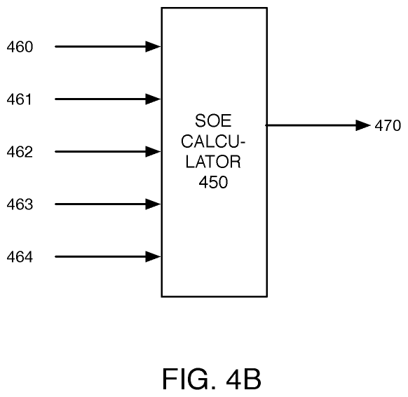

FIG. 4A is a schematic block diagram of BMS 110. Temperature sensor circuitry 400 receives inputs 300 from battery pack 105 (FIG. 3), and provides one or more outputs to microprocessor circuit 430. Current monitor circuitry 410 receives inputs 301 from battery pack 105, and provides one or more outputs to microprocessor circuit 430. Voltage monitor circuitry 420 receives inputs 302 from battery pack 105, and provides one or more outputs to microprocessor circuit 430. While the embodiment of FIG. 4A includes circuitry components 400, 410 and 420 within BMS 110, it is contemplated and understood that in other embodiments, for example, some or all components of such circuitry could be integrated directly within battery pack 105.

BMS 110 also includes digital memory 440. Digital memory 440 may be utilized to store, and make available to microprocessor 430, information including battery pack operating history 441 and battery cell characterization data 442. Battery operating history 441 may include various types of historical battery module operating information, for example, historical duty cycles, peak and sustained discharge rates, prior operating temperatures, module age, and the like. Battery cell characterization data 442 may include information characterizing the physical or electrochemical characteristics of cells within battery pack 105, including, without limitation, information descriptive of the response of a group of and/or all of the cells within battery pack 105 to various conditions. Because BMS 110 is typically integrated within battery module 100, a battery module manufacturer may utilize battery cell characterization data 442 to enable operating parameters to incorporate the module manufacturer's own characterization of battery cells within pack 105.

In operation, BMS 110 may still receive similar state data from battery pack 105 (e.g. one or more temperatures 300, one or more voltages 301 and one or more currents 302, etc.). BMS 110 (and in particular, microprocessor 430) may then use those inputs to derive an SOE output 310, state data output(s) 315 and warnings or other messaging 320. State data outputs 315 may include, for example, analogous information to BMS outputs 260-265 in the embodiment of FIG. 2, although the frequency and scope of data provided may, in some embodiments, be reduced, because VMU 220 may no longer rely on that data (or may have less reliance on that data) to control real time operation of inverters 240 or other system components.

Instead, SOE output 310 may provide VMU 120 with a fully-synthesized characterization of constraints on system demands to be placed on battery module 100. By utilizing locally-obtained measurements (such as measurements 300, 301 and 302) rather than operating data conveyed over a shared communications bus, BMS microprocessor 430 may utilize a higher sample rate, and a greater number of measurements, with lower latency, in deriving SOE output 310, as compared to alternative derivations that might be performed on VMU 120.

In some embodiments, SOE output 310 may include a real-time or substantially real-time maximum recommended battery module output or input for battery module 100. SOE output 310 may be expressed as, for example, a current level (e.g. a number of amps) that may be drawn from (in a discharge operation) or input to (in a charging operation) battery module 100. SOE output 310 may also express a power level (e.g. a number of watts or kilowatts) with which battery module 100 may be charged or discharged.

SOE output 310 may be determined in such a manner as to maintain the battery module within desired operating constraints. FIG. 4B illustrates an exemplary embodiment of a SOE calculator, which may be implemented by application logic executed by microprocessor 430 in BMS 110. SOE calculator 450 performs a calculation using at least one of battery pack voltage measurements 460, current measurements 461, temperature measurements 462, battery module history information 463, and cell characterization 464, in order to generate SOE output 470. In some embodiments, SOE calculator 450 may implement a linear equation using microprocessor 430. In some embodiments, SOE calculator 450 may implement a nonlinear equation using microprocessor 430. In some embodiments, SOE calculator 450 may implement a machine learning component using microprocessor 430.

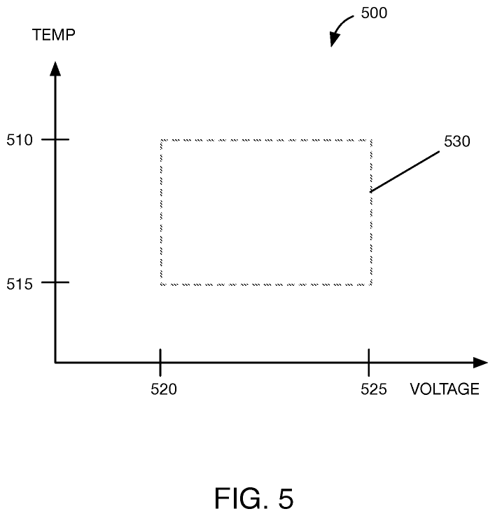

For example, in some embodiments, SOE output 310 may be optimized to maintain battery pack 105 within desired ranges of temperature and voltage, as illustrated in the embodiment of FIG. 5. Graph 500 plots battery pack temperature versus voltage level. Operating temperatures in excess of maximum temperature threshold 510 and/or operating voltage levels in excess of maximum voltage threshold 525 may, for example, expose the battery pack to unacceptable risk of damage or safety concerns (such as thermal runaway). Temperatures below minimum temperature threshold 515 may, for example, yield unacceptably reduced performance and/or cell damage. Voltage levels below lower threshold 520 may, for example, result in lithium plating problems. Thus, in operation, BMS 110 may determine SOE output 310 so that a vehicle or other system operating within the SOE-specified load range will maintain battery pack 105 within the desired voltage and temperature region 530.

While desired voltage and temperature region 530 is illustrated in FIG. 5 as a simple rectangular region defined by fixed maximum and minimum voltages and temperatures, it is contemplated and understood that, even in embodiments with SOE defined to maintain desired operating voltage and temperature relationships, other relationships may be defined. In some embodiments, voltage and temperature thresholds may be dynamic, and based in part on other information, such as pack history 441 and battery cell characterization data 442. For example, as a pack ages, it may be desirable to reduce maximum operating temperatures. As another example, if historical pack operating conditions characterized in memory 441 resulted in escalating pack temperatures, subsequent SOE outputs may be determined to reduce threshold voltages and/or temperatures to avoid such escalation. In yet other embodiments, voltage thresholds may be a function of temperature, and vice versa, such that desired region 530 is expressed as a curved region. These and other types of relationships may be utilized in order to generate SOE output 310.

In some applications, it may be desirable to enable swapping of battery module 100. For example, in electric vehicle applications, it may be desirable to enable battery modules to be swapped when a module's state of health falls below a threshold level, in response to a malfunction, or even swapping an empty module for a fully charged module as a “quick recharge” option. By including memory 440 and calculating SOE 310 locally, within battery module 100, historical operating data 441 and battery cell characterization data 442 stays within the battery module. Thus, rather than having to “reset” such information with each battery swap, installation of a substitute battery module will provide the receiving system with rich information for use in determining SOE 310. In-module storage and utilization of historical operating data 441 and/or battery cell characterization data 442 may be similarly (or even more) beneficial in other, non-vehicular applications, such as stationary energy storage. For example, cellular telephone infrastructure may be relocated or upgraded. In other industrial applications, battery packs may get swapped between different pieces of equipment, job sites, or the like. By determining SOE parameters within a battery module where historical operating information and/or cell characterization data is also stored, SOE determinations can be made using the best and most relevant information available.

By providing a battery module having an SOE output, a system integrator's design task may also be simplified. System integrators can rely on battery module manufacturers to optimize battery pack operating characteristics, rather than having to develop and implement their own systems and constraints for battery module operation.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

What is claimed is:

1. A battery module comprising:
a plurality of battery cells within a battery pack; and
a battery management system integrated within the battery module, the battery management system comprising:
one or more temperature sensors monitoring one or more locations within the battery pack;
one or more voltage sensors monitoring voltage at one or more battery cells within the battery pack;
one or more current sensors monitoring current of the one or more battery cells within the battery pack;
a digital memory storing at least one of historical battery module operating information and one or more battery cells characterization data; and
a microprocessor outputting a battery module safe operating limit, based at least in part on outputs from the temperature sensors, the voltage sensors, the current sensors, at least one of the historical battery module operating information and the one or more battery cells characterization data.

2. The battery module of claim 1, wherein the safe operating limit is synthesized as an envelope (SOE) of safe operation limits or ranges and is a characterization of operational constraints to be placed on the battery module.

3. The battery module of claim 1, wherein the historical battery module operating information contains at least one of historical duty cycles, peak and sustained discharge rates, prior operating temperatures, and battery module age.

4. The battery module of claim 2, wherein the SOE includes a substantially real-time maximum recommended battery module output or input.

5. The battery module of claim 1, wherein the microprocessor also outputs at least one reading of the temperature sensors, the voltage sensors, and the current sensors.

6. The battery module of claim 2, further comprising:
a digital communication bus, receiving at least one of a state data, warning information and the SOE.

7. The battery module of claim 6, wherein the state data includes at least one of a state of charge (SOC) in the battery pack, state of health (SOH) of the battery module, one or more voltage levels, one or more temperature readings, and a battery module current level.

8. The battery module of claim 6, further comprising a management unit, external to the battery module and coupled to the digital communication bus.

9. The battery module of claim 8, further comprising a load controlled by the management unit.

10. The battery module of claim 9, wherein the load is an inverter.

11. The battery module of claim 9, wherein the load is an electrical motor.

12. The battery module of claim 11, wherein the electrical motor is in a vehicle.

13. The battery module of claim 12, wherein the digital communication bus is a Controller Area Network BUS.

14. The battery module of claim 1, further comprising a plurality of the battery modules, each battery module containing a plurality of battery cells within a battery pack, and a battery management system integrated within each battery module.

15. The battery module of claim 1, wherein the one or more battery cells characterization data is from a manufacturer of the battery cells.

16. A battery management system, comprising:
temperature sensors;
voltage sensors;
current sensors;
a digital memory storing a historical battery module operating information and battery cell characterization data; and
a microprocessor outputting a battery module safe operating limit, based at least in part on outputs from the temperature sensors, the voltage sensors, the current sensors, at least one of the historical battery module operating information and the battery cell characterization data.

17. A method for controlling operation of an electric device powered by a high-density battery module, the method comprising:
determining, by a microprocessor integrated within the battery module, a characterization of constraints which provide a range of currently acceptable operating conditions on the battery module, based on local sensor measurements of the battery module and information stored within the battery module concerning historical module operations and battery characteristics;
transmitting the characterization of constraints on to a system management unit via a shared digital communications bus; and
controlling, by the system management unit, the operation of a load circuit to avoid exceeding the characterization of constraints.

18. The method of claim 17, wherein the characterization of constraints is locally synthesized.

19. The method of claim 17, further comprising storing, within the battery module, manufacturer cell characterization information for battery cells within the battery module.

20. The method of claim 17, further sending from the battery module, a battery state data and warning to the system management unit.
